(19) United States
(12) Patent Application Publication
(10) Pub. No.: US 2009/0210144 A1
(43) Pub. Date: Aug. 20, 2009

(54) METHOD FOR SELECTING A DESTINATION

(76) Inventors: Andreas Jungk, Esslingen (DE); Stefan Auberg, Korntal-Muenchingen (DE)

Correspondence Address: KENYON & KENYON LLP, ONE BROADWAY, NEW YORK, NY, 10004, US

(21) Appl. No.: 12/303,234

(22) PCT Filed: Sep. 5, 2007
(86) PCT No.: PCT/EP2007/059271

§ 371 Date: Dec. 2, 2008

(30) Foreign Application Priority Data
Oct. 31, 2006 (DE) 102006051331.2

(51) Int. Cl. G01C 21/00

(52) U.S. Cl. 701/200

(57) ABSTRACT

A method for selecting a driving destination from a set of stored localities, a locality name being inputted for comparison of the inputted locality name with stored locality names, and at least one of the stored localities being determined, from the comparison of the inputted locality name, as a possible driving destination, in which a further locality is determined, a vicinity of the further locality is determined, and a locality determined as possible from the comparison is outputted for selection as a driving destination when the locality is in the determined vicinity of the further locality.

### FIELD OF THE INVENTION

The present invention proceeds from a method for selecting a driving destination, or from a navigation apparatus.

### BACKGROUND OF THE INVENTION

German patent document DE 197 42 054 A1 discusses an input system, at least for locality and/or street names, that has a data source assemblage which has, in addition to a first locality and/or street list having alphabetically sorted locality and/or street names, at least one second locality and/or street list having locality and/or street names sorted according to a frequency criterion. Voice inputs are forwarded from a voice input system of an input assemblage to a control assemblage. Not only the number of residents of a locality or the number of residents living on a street, but also a search frequency of localities or streets constituted from empirical values, can be used as a frequency criterion.

### SUMMARY OF THE INVENTION

The method according to the present invention for selecting a driving destination, having the features of Claim 1, has, in contrast thereto, the advantage that a determination of a locality as a driving destination is simplified by the selection of a vicinity around a further locality. According to the existing art cited, firstly a search is made among those localities whose probability is particularly high. If the locality is not contained in this set, a comparison with the entire database must be carried out. In accordance with the method according to the present invention, however, the search can instead be limited, by an additional user input, to a specific destination vicinity. The set of locality names with which the inputted locality name is compared can thereby be made smaller, so that not only does the probability of a correct recognition rise, but the time required for a determination of the indicated locality is decreased. Selection of a vicinity by the user is a criterion which can easily and intuitively be grasped by a user, and with which the set of locality names with which a comparison is to be carried out can be effectively limited. Because the comparison can be carried out easily, memory requirements and processor performance can also be reduced without creating disadvantages for a user. In particular, subsequent queries regarding similar or identically named localities can, if applicable, be avoided, since other identically named localities are possibly not located in the selected vicinity.

Corresponding advantages result for a navigation apparatus according to the coordinated claim, in which apparatus a destination input is made in particular in order to carry out a travel route calculation to the inputted driving destination. With utilization in a vehicle, the time necessary for inputting the driving destination using the navigation apparatus according to the present invention can be decreased, and user convenience for the driver of the vehicle can thus be enhanced.

The features set forth in the dependent claims make possible advantageous refinements of and improvements to the navigation apparatus described in the independent claims, and the method described for selecting a driving destination. It is advantageous in this context to limit the comparison of an indicated locality name to a vicinity of the locality at which the input is carried out. For example, if a vehicle having a positioning apparatus is located at a specific locality in a road network, the comparison of the inputted locality name is carried out only with localities in the vicinity of that locality.

It is additionally advantageous that the further locality for comparison is inputted by a user. The user, who generally knows the region in which his or her driving destination is located, can thereby limit the set of locality names that are compared with the inputted driving destination. A limitation is thus also possible independently of a present locality at which the input is carried out.

It is additionally advantageous to input the locality name and/or a name of the further locality via a voice input. A voice input in particular is complex in terms of the processing of inputted voice signals, so that a simplification of the comparison when a voice input is carried out produces particularly large savings with regard to calculation time and the calculation resources required. Because errors can occasionally occur in voice input as a result of locality names that sound similar or identical, error frequency can additionally be decreased by way of the limitation to the desired vicinity. With the input according to the present invention, voice input becomes not only faster but also more reliable.

It is advantageous to describe the vicinity of the further locality by way of a circumscribed circle having a defined radius. A corresponding radius, which is either predefined, dependent on the further locality, or modifiable by the user, is an intuitive criterion that is easily graspable by the user, so that the user can readily assess the consequences of limiting the comparison to the vicinity.

It is additionally advantageous to select the radius as a function of the population density. The radius selected can thus be larger in sparsely settled areas, and smaller in densely settled areas. In densely settled areas, it is to be assumed that a larger number of localities is also present. The set of locality names that are used for the comparison can thus be kept approximately the same in sparsely settled and in densely settled areas.

It is additionally advantageous to define an administrative area, for example a district, urban area, or regional area, as a further vicinity. A user can then, with a knowledge of the particular administrative area, successfully limit the set of locality names for a comparison independently of any radius.

Advantageously, firstly the locality name is inputted, and a comparison is made with a first set of locality names. Locality names that are traveled to with particular frequency, particularly large cities, or localities traveled to with particular probability for another reason, can be stored in this first set. Smaller localities, the selection of which is not probable, are not allocated to this first set. For the case in which the inputted locality cannot be found in the first set, additional determination of the further locality can limit the comparison to the vicinity of the further locality; a second set, which corresponds to the vicinity of the further locality, contains locality names that are not contained in the first set of locality names that was used. According to an embodiment, all locality names that are selectable in the vicinity of the further locality are contained in the second set. This on the one hand enables a rapid selection of a particularly probable travel destination, while on the other hand determination of the further locality makes possible a detailed selection, i.e. specifically including selection of smaller localities, without enlarging the set of locality names employed for the comparison.

Exemplifying embodiments of the invention are depicted in the drawings and explained further in the description that follows.

### BRIEF DESCRIPTION OF THE DRAWINGS

FIG. 1 shows a navigation apparatus according to the present invention.

FIG. 2 depicts an area with localities, to each of which locality names are assigned and from which a driving destination is determined in accordance with the present invention.

FIG. 3 illustrates execution of a navigation method for guiding a vehicle to a driving destination.

FIG. 4 shows a method according to the present invention for selecting a driving destination from a set of stored localities.

### DETAILED DESCRIPTION

The method according to the present invention for selecting a driving destination can be used for any computer-assisted methods for selecting a driving destination. Utilization is advantageous in particular for a navigation system in a motor vehicle, in which a driver inputs a driving destination and a travel route to a locality is determined. The term “locality” or “locality name” is to be understood here not only as the designation of a town or village, but also as any further locality designation. In particular, the designations of particular objects such as, for example, places of interest, government agencies, performance locations, or restaurants, but also street names, land designations, fueling stations, or rest areas, can also be understood under this term.

The advantages of the exemplary embodiments and/or exemplary methods of the present invention are already apparent, however, upon selection of a town, a village, or a city district using the method according to the present invention for selecting a driving destination. For the larger European countries, for example, in order to input a driving destination it is necessary to make a selection from approximately 80,000 town names. The exemplary embodiments and/or exemplary methods of the present invention is therefore explained hereinafter using the example of selecting a town name. By selecting a group of different categories of locality designations, for example street names, particular objects, and towns, or by selecting locality names by category (e.g. only from the designation of particular objects), the invention can correspondingly also be applied, via a selection of a driving destination, for other types of locality designations.

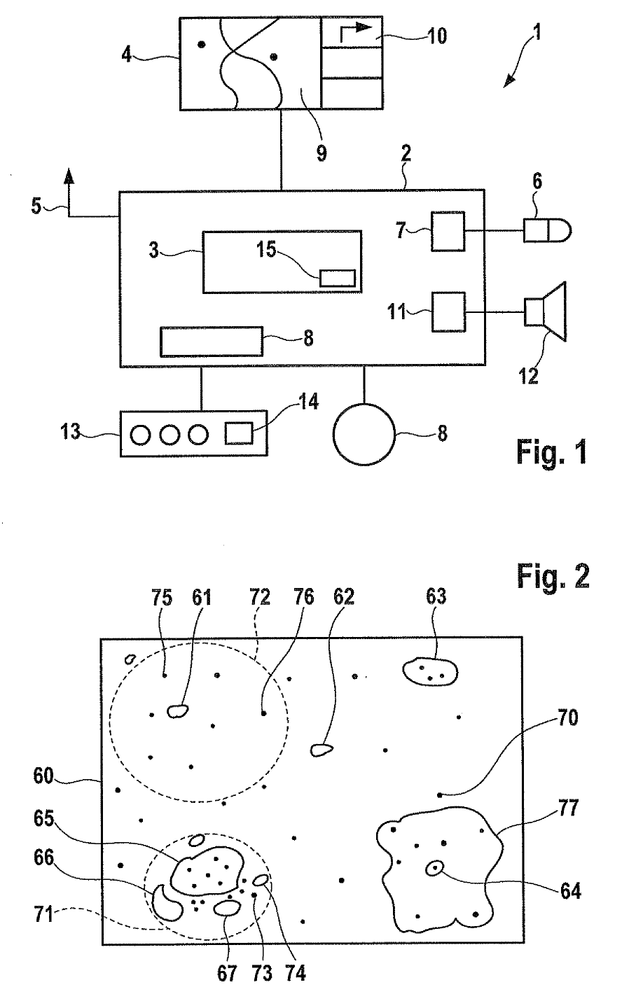

FIG. 1 depicts a navigation apparatus 1 in a vehicle. Navigation apparatus 1 has a central unit 2, which possesses a calculation unit 3 and to which a display unit 4 is connected. Central unit 2 is further connected to a positioning unit 5 that determines, for example by satellite positioning, a position of the vehicle in a road network. Central unit 2 is furthermore connected to a microphone 6 that enables a voice input by a user. A voice processing unit 7 processes the received voice signals and conveys the processed signals to calculation unit 3. By accessing a storage unit 8, for example a CD drive having a corresponding data medium on which a map area having locality names is stored, calculation unit 3 carries out a determination of the driving destination, as will be explained below.

A program for controlling calculation unit 3 may be stored in a memory 8 of central unit 2. From the present position determined via positioning unit 5, and from the inputted driving destination, calculation unit 3 determines a travel route from the present position to the inputted driving destination. This travel route is depicted, for example, in a map depiction 9 in display unit 4. Turn instructions can furthermore be outputted optically and/or acoustically. For an optical output, for example, an arrow depiction 10 can occur in display 4. An acoustic output may occur via a voice generation unit 11 that conveys corresponding turn instructions in spoken form to a loudspeaker 12. Alternatively or in addition to the voice input via microphone 6, navigation apparatus 1 can also be controlled via a keypad 13. In this context, a locality name can be inputted via keypad 13 into navigation apparatus 1. The locality name inputted via keypad 13, or the locality name inputted via microphone 6, is depicted in display unit 4 for verification, or outputted via acoustic output unit 12 for verification. If a confirmation then occurs, either e.g. via a confirmation input via microphone 6 or by the pressing of a confirmation key 14, the inputted locality name is used as a driving destination.

In memory 8, locality names are each stored with a name designation that is linked to a geographical coordinate, so that a position in the road network or in the map area is allocated to each locality name in memory 8. The geographical coordinates of the longitude and latitude can be used to identify the position of a locality. It is additionally possible to use so-called WGS-84 coordinates for position identification. Calculation unit 3 may be configured so that a comparison of the inputted locality name allows identification of a similar locality name even in the context of a deviation from stored locality names, e.g. a locality not yet completely inputted, incorrect spelling, or incorrect pronunciation. In an embodiment, corresponding phonetic transcription information for pronunciation of the locality names, which information is used for identification using inputted voice signals, is also stored for the locality names. A program for controlling comparison of the inputted locality name with stored locality names is, for example, likewise stored in memory 8.

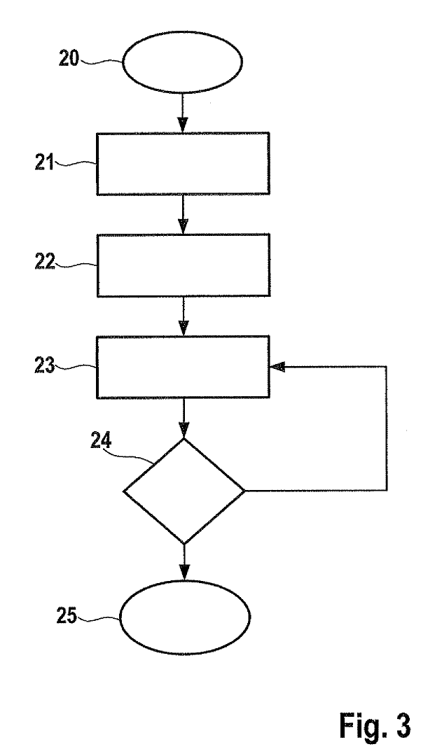

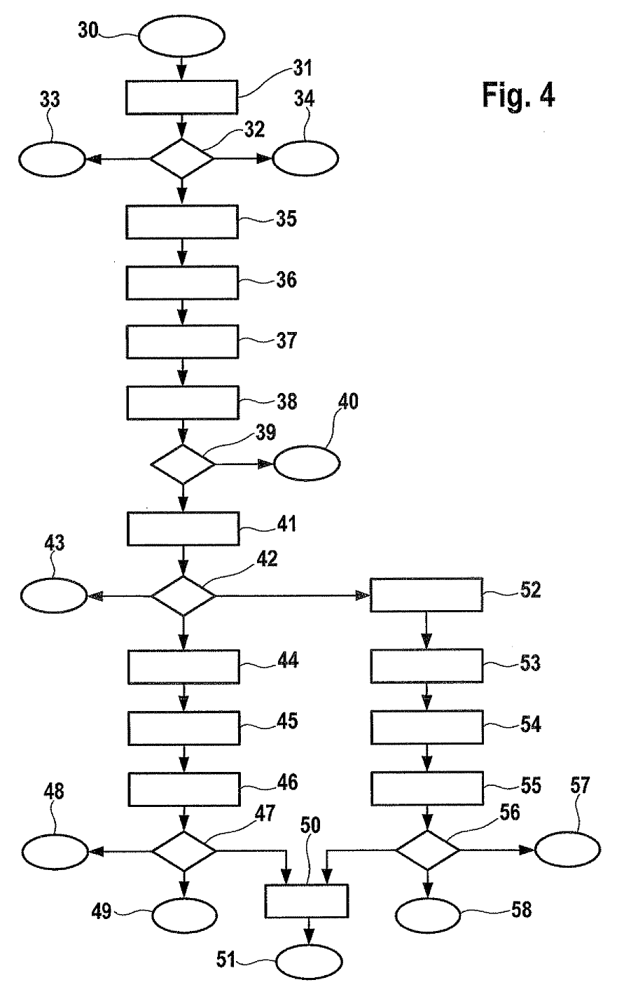

A method according to the present invention for carrying out vehicle navigation is depicted in FIG. 3. Starting from an initialization step 20, a route guidance is started, navigation apparatus 1 being initialized and a request for input of a driving destination being made. In a subsequent input step 21, which is further explained with reference to FIG. 4, a driving destination is inputted. In a following route calculation step 22, a travel route from the vehicle's position to the inputted driving destination is calculated. Then, in an output step 23, driving instructions that guide the vehicle along the calculated travel route are outputted. In a subsequent checking step 24, a check is made as to whether the driving destination has already been reached. If so, vehicle guidance is terminated in a end step 25. If the response in checking step 24 is negative, execution then branches back to output step 23 in order to output the next driving instruction.

FIG. 4 describes the input of a driving destination into navigation apparatus 1. Proceeding from a starting step 30, driving destination input is initialized. For this, for example, “Please input a driving destination” is presented in display 4, or a corresponding request is outputted via loudspeaker 12. In a subsequent first input step 31, a user selects the type of driving destination input. A subsequent checking step 32 checks which input type the user has selected. A first input type 33, in which firstly a category of driving destinations is selected (e.g. the category “Restaurants” or “Museums”) is merely indicated here by way of example, but not further explained. According to a further input type 34, a driving destination is selected from a list of stored driving destinations that a user has previously stored in a memory. Further ways of selecting a driving destination are conceivable. If the user selects selection of a town name, execution then branches from first checking step 32 to a loading step 35. In another embodiment, steps 31 and 32 can also be omitted, and loading step 35 can immediately follow starting step 30.

In loading step 35, calculation unit 3 determines a subset of locality names that are transferred into a working memory 15 of calculation unit 3 for performance of a comparison of an input with the stored locality names. In a subsequent input step 36, a user then inputs a locality name. The input may occur via microphone 6 and voice processing unit 7. In a subsequent comparison step 37, the inputted locality name is compared with the locality names stored in volatile memory 15. In a first embodiment, what is outputted as a result of the comparison is a locality name that exhibits the greatest similarity to the inputted locality name. In another embodiment, multiple locality names are outputted, in particular in the case of identically pronounced or very similar locality names. In the present case, however, in the interest of a clear presentation, the input is assumed to be unequivocal.

In a following inquiry step 39, the user is asked whether the inputted locality name is to be selected as a driving destination. If this is confirmed by the user, the locality associated with the selected locality name, i.e. in particular its geographical position in the road network, is then selected as a driving destination in a definition step 40, and the navigation method continues with route calculation step 22 as shown in FIG. 3. If, however, the user indicates that the outputted locality name is not the driving destination, execution then branches on to a selection step 41 in which the user selects a method for specifying his or her driving destination.

A subsequent checking step 42 checks as to which method for specification a user has selected. In a first embodiment, a user selects a search in a vicinity around the present vehicle position. In a second alternative, a user selects a search in a vicinity around a further locality yet to be inputted by him or her. In further alternatives, a user can also perform a category selection here, for example for restaurants or museums, or a different selection. A selection of this kind is indicated by method step 43 (not further explained).

According to the first alternative, i.e. selection around the present vehicle position, execution branches to a loading step 44. In loading step 44, calculation unit 3 loads a set of locality names in a vicinity of the present vehicle position, for example with a radius of 15 km around the present vehicle position, from memory 8 into volatile memory 15. The loaded locality names replace the locality names previously stored therein according to loading step 35. In a subsequent input step 45, a comparison of the previously inputted locality name with the locality names transferred into volatile memory 15 is now carried out, and one of the locality names is ascertained and, in the following output step 46, outputted via display 4 and/or via loudspeaker 12. In a subsequent checking step 47, the user is asked whether the locality name depicted is to be selected as a driving destination. If this is affirmed, or if there is no input within a predefined time, the locality name depicted is selected, according to a method step 48, as the desired locality name, and the navigation method as shown in FIG. 3 is pursued with route calculation step 22. If the locality name depicted is not the desired locality name, the method is discontinued in an end step 49, and the user must repeat the locality name input. Possibly his or her voice input was not unequivocally understood. In the case of a keypad input, there was possibly a spelling mistake. In an alternative embodiment, in the context of an implementation as a voice input it is now possible to switch from an input as an entire word to an input of the locality name by speaking the individual letters of the locality name, so that the locality name is spelled out.

For the case in which the locality name occurs several times in the vicinity, execution then branches to a decision step 50 in which the user is requested to select one of the locality names. Once a selection has been made, in a definition step 51 the selected locality name is selected, in accordance with step 48, as the desired locality name.

According to the second alternative, execution branches from checking step 42 to an input step 52 in which the user indicates the further locality. In a loading step 53 a vicinity for the further locality is then determined, so that the locality names are loaded from memory 8 into volatile memory 15. These are, for example, all localities located in the rural district of the selected further locality. In addition, these localities can also be located in a vicinity determined by a radius around said locality. Then, according to step 45, a comparison is made of the previously inputted locality name with the locality names now loaded into volatile memory 15 in a comparison step 54. In accordance with step 46, in an output step 55 a presentation of the locality name in display 4 is then made, and/or an acoustic output of the selected locality name via loudspeaker 12. In a subsequent checking step 56, the user is asked whether he or she agrees with the selected locality name. If so, execution then accordingly branches, in step 48, to a definition step 57 in which the selected locality name is defined as a driving destination, so that the navigation method can be pursued with route calculation step 22. In accordance with step 49, for the case in which the inputted locality name is incorrect, the method is terminated in an end step 58 or the user can alternatively, in the context of a voice input, input the locality name by spelling. For the case in which the locality name occurs several times in the vicinity of the further locality, execution branches to decision step 50.

The method according to the present invention is explained once again in FIG. 2 on the basis of a map depiction. FIG. 2 depicts settlements of various sizes, smaller localities being depicted as dots and larger localities with a border. Map area 60 is intended to represent the totality of the map area in memory 8. In practice, map area 60 may be constituted by the entire territory of one or more countries. In accordance with first loading step 35, at first only the locality names of larger localities, i.e. according to FIG. 2 the locality names of localities 61, 62, 63, 64, 65, 66, and 67, are loaded for comparison. The remaining, smaller localities, in particular the localities depicted as dots, for example locality 70, are not loaded in first loading step 35. In particular, they are not utilized for a comparison in the following comparison step 37. If the vehicle is then located in city 65, and if the user selects a search in the vicinity of the vehicle, vicinity 71 shown with a dashed line is then defined as a vicinity of the further locality, namely as a vicinity of city 65. The same also applies for the case in which the vehicle has stopped, for example, in locality 70 and the driver selects a search around the further locality 65. If the driver selects a search around locality 61, a larger vicinity 72 is then selected, since the population density in the area of city 65 is greater than in the area around city 61.

If the user then selects the vicinity of city 65, localities 61, 62, 63, and 64 are then no longer utilized for a comparison after the selection, but all localities in vicinity 71 are, for example including localities 73 and 74. Localities 66 and 67 are sufficiently large that they were also already contained in the first selection. Because they are also in the vicinity of locality 65, they are also available for the further comparison.

The radius of a vicinity can be defined automatically as a function of population density. It is also possible, furthermore, for a user to select a radius, for example via keypad 13. The radius can thus fluctuate, for example, between 5 km and 100 km as the user desires. A larger radius is advantageous in particular when a further criterion enters into selection of the vicinity, for example an additional category criterion such as “Hotel,” “Museum,” or “Restaurant.”

If multiple identically named localities are present in the map region, a selection can be made accordingly by defining a vicinity. For the case in which, for example, localities 74, 75, 76, and 63 had the same name, with correct detection of the locality name only the locality name of locality name 63 would then be outputted in output step 38. If a user were then to select the vicinity of city 65, only locality name 74 would then be outputted. If a user were, on the other hand, to select the vicinity of locality 61, then the locality names of localities 75 and 76 would be outputted. These localities are identified in the output by, for example, an additional criterion, for example by belonging to an administrative area.

It is additionally possible to identify a vicinity by way of an administrative area, for example a district boundary. An administrative area of this kind can be, for example, a rural district, indicated by area 77 with city 64 as a district town.

Instead of an operation of loading all the locality names from memory 8 into volatile memory 15, it may also be possible to carry out the search directly in memory 8. In another embodiment, it is also possible to have the input of a locality name occur first, and to utilize the input as an additional criterion for the transfer of data from memory 8. It would thus be possible, for example, to determine a first sound, a first syllable, or a first letter of the locality name, and to additionally utilize that criterion for the transfer of data from memory 8 into volatile memory 15.

The invention will be explained below once more with reference to concrete examples for the selection of a driving destination. Input is described here using the example of a voice input by the user. According to a first scenario, a driving destination input is initiated by inputting the command “Destination input.” The navigation apparatus then asks, via a voice output and/or via display 4: “What do you want to input?” The user then responds: “Input city.” The list of larger cities may then be loaded, as was explained with reference to FIG. 2. The user is then requested to input the desired target locality. The user replies to this with “Hildesheim.” The spoken audio data of this user input is stored, and is compared with the locality name list. Because Hildesheim is a large city, it had already been loaded with a list of larger German cities. The navigation apparatus then asks: “Did you say Hildesheim?” This is answered in the affirmative by the user, so that destination guidance to the city center of Hildesheim can begin.

In another example, the user replies to the question as to the desired destination locality with “Petze.” The town of Petze is too small, however, so voice processing unit 7 detects the town as “Peine.” The system accordingly asks: “Did you say Peine?” The user replies to this with “No, search in the vicinity.” The first alternative is then accordingly selected from checking step 42, and a search in the vicinity of the present position is carried out. For the case in which the vehicle is located close to the town of Petze, this locality name (among others) is taken into consideration for the comparison. The output to the user is thus: “Did you say Petze?” The user replies to this with “Yes, start destination guidance,” so that the town center of the locality of Petze is regarded as the driving destination. For the case in which the vehicle is not located close to Petze, in accordance with the exemplifying embodiment just presented the driver replies to the response “Did you say Petze?” with “No, search around a larger town.” The input is now reduced to a list with larger towns for input of the further locality. Alternatively, a place of interest can now also be searched for as a further locality, for example by way of the command “No, search around a place of interest.”

The driver replies to the question regarding the search around a larger town with “Hildesheim.” This may be checked by the navigation apparatus by way of an additional query. In the present case this query is “Do you want to search around Hildesheim?” The user replies “Yes.” In a further embodiment, the input can also occur in such a way that instead of the input “No, search around a larger town,” the user gives the input “No, search around Hildesheim.”

The navigation apparatus then once again loads a list of towns in the vicinity of Hildesheim. A comparison is then performed between these towns and the locality input “Petze” already performed previously. Because Petze is located close to Hildesheim, the result of the comparison is positive, so that the locality name is found. The output produced is “Did you say Petze?” to which the user replies “Yes, start destination guidance.”

In a further embodiment, it is also possible to input the further locality first, only thereafter to carry out the input of a locality name of the driving destination, and for this to be followed by comparison with the locality names in the vicinity of the further locality. According to this embodiment, a driver firstly inputs “Search around Hildesheim.” The question “Search for what locality in the vicinity of Hildesheim?” is then answered by the driver with “Petze.” This is then followed by a comparison of the input “Petze” with localities in the vicinity of Hildesheim, so that the locality Petze is found and selected as a driving destination. The driver can also correspondingly, by way of a “Search in the vicinity” input, confine a comparison of a subsequent input to a vicinity around the present vehicle position.

In a larger country, locality names are often present more than once. For example, there are approximately 90 localities named “Neuhof” in Germany. In order to avoid unnecessary user querying in order to resolve any ambiguities, input of the further locality can additionally be used in order to filter out, as a desired driving destination, the locality name sought by a user. If multiple localities having the same name exist in the search region, the user must then be offered only the actually relevant locality names in order to resolve ambiguities. For example, if the user replies “Neuhof” to the question as to the desired destination, he or she will first be asked “Did you say Neustadt?” since none of the localities named Neuhof is large enough for inclusion in the list of larger towns of, for example, more than 50,000 residents. If the user replies to this with “No, search in the vicinity,” a vicinity list of towns around the present position is loaded. For the case in which multiple localities having the same name exist in the vicinity, an additional item of information is also acquired. For example, for the case in which the vehicle is located between the localities of Neuhof near Hannover and Neuhof near Hildesheim, and both localities are in the vicinity of the present position, the response is: “Did you say Neuhof? This locality appears more than once. Please select Neuhof/Hildesheim or Neuhof/Hannover.” The user can then, by inputting “Neuhof/Hildesheim,” select that locality.

1-11. (canceled)

12. A method for selecting a driving destination from a set of stored localities, the method comprising:
inputting a locality name;
comparing the inputted locality name with stored locality names, at least one of the stored localities being determined, from the comparison of the inputted locality name, as a possible driving destination;
determining a further locality, a vicinity of the further locality; and
outputting a locality determined from the comparison as a possible driving destination for selection as a driving destination when the locality is in the determined vicinity of the further locality.

13. The method of claim 12, wherein a locality at which the input is carried out is ascertained, and that locality is determined as the further locality.

14. The method of claim 12, wherein the further locality is determined by a user.

15. The method of claim 12, wherein at least one of the locality name and a name of the further locality are inputted via a voice input.

16. The method of claim 12, wherein the vicinity of the further locality is described by a circumscribed circle having a defined radius around the further locality.

17. The method of claim 16, wherein a radius of the circumscribed circle depends on the population density in the vicinity around the further locality.

18. The method of claim 12, wherein the vicinity is described by the boundaries of an administrative area in which the further locality is located.

19. The method of claim 12, wherein the inputted locality name is firstly, prior to a consideration of the further locality, compared with a first set of the stored locality names, and after determination of the vicinity of the further locality is compared with a second set of the stored locality names that differs from the first set.

20. The method of claim 19, wherein locality names that are not contained in the first set are contained in the second set.

21. A navigation apparatus in a vehicle, comprising:
an input unit to input locality names;
a memory unit to store the locality names;
a processing unit to compare an inputted locality name with the locality names stored in the memory unit and for determining a vicinity of a further locality for limiting the comparison to a comparison of the inputted locality name with locality names of localities in the vicinity of the further locality; and
an output unit to output, as a proposed driving destination, at least one locality resulting from the comparison.

22. The navigation apparatus of claim 21, wherein the input device includes a voice input unit.
